(19) United States
(12) Patent Application Publication
(10) Pub. No.: US 2016/0311955 A1
(43) Pub. Date: Oct. 27, 2016

(54) PROCESS FOR PRODUCING SHORT-CHAIN MACROMOLECULES BASED ON ACRYLATE MONOMERS

(71) Applicant: TESA SE, Norderstedt (DE)

(72) Inventors: Bernd LÜHMANN, Norderstedt (DE); Alexander PRENZEL, Hamburg (DE); Benjamin PÜTZ, Hamburg (DE); Helmut RITTER, Woppertal (DE); Stephan ZÖLLNER, Buchholz /Nordheide (DE)

(73) Assignee: TESA SE, Norderstedt (DE)

(21) Appl. No.: 15/104,308

(22) PCT Filed: Nov. 19, 2014
(86) PCT No.: PCT/EP2014/075018

§ 371 Date: Jun. 14, 2016

(30) Foreign Application Priority Data
Dec. 18, 2013 (DE) 102013226503.4

(51) Int. Cl. C08F 220/18

(52) U.S. Cl. CPC C08F 220/18

(57) ABSTRACT

Acrylate-based oligomers having double-bond end-group-functionalization are produced by means of free-radical polymerization where, in a first step, a monomer mixture of an acrylate component and an aromatic component is reacted with use of a difunctional regulator, the molar quantity of monomer mixture to that of regulator being from 100:20 to 100:0.5 and the polymerization is continued until monomer conversion reaches at least 96%. In a second step, the resultant macromolecules are reacted, in the reactor in which the polymerization was conducted, with at least one compound Z which has a functional group and has an ethylenic doule bond, and at least that portion of the compound Z that contains the ethylenic double bond becomes linked to the macromolecules via reaction of one of the functional groups of the difunctional regulator with the functional group of the compound Z.

This is a 371 of PCT/EP2014/075018 filed 19 Nov. 2014, which claims foreign priority benefit under 35 U.S.C. 119 of German Patent Application 10 2013 226 503.4 filed Dec. 18, 2013, the entire contents of which are incorporated herein by reference. what

The invention relates to a process for producing short-chain polymers based on free-radical polymerizable acrylate monomers. The polymers have a functional group capable of addition or substitution at one chain end.

### BACKGROUND OF THE INVENTION

In the chemical industry there exists an increasing interest in end-group-functionalized short-chain polymers with controlled degrees of functionality, i.e. having as far as possible identical number of corresponding functions per polymer. Such short-chain polymers may be used as macromolecules to form higher polymers for example, but are also useful for numerous further reactions.

One method for forming high molecular weight polymer systems is the use of end-group-functionalized macromolecules. Such end-group-functionalized short-chain macromolecules are therefore also referred to as prepolymers (in a broad sense “prepolymers” are understood to mean those oligomeric to polymeric compounds—particularly obtainable as an intermediate stage—which are provided for further processing to high molecular weight polymers). Macromolecules used as prepolymers are frequently in the molar mass range of 500 to ca. 100 000 g/mol, particularly in the range of 1000 to 20 000 g/mol. The field of application of these prepolymers is therefore as a component of numerous different reactions.

End-group-functionalized macromolecules may be generated by suitable production and polymerization processes. However, it is often difficult to produce macromolecules having co-polymerizable terminal groups in polymerization reactions since the co-polymerizable group itself already tends to participate in the polymerization reaction. Thus, a route can be taken where a poorly or non-copolymerizable terminal functional group of the macromolecules can be converted into an end group capable of polymerization, particularly a free-radical polymerization, only by a modification downstream of the polymerization, in order to obtain refunctionalized macromolecules as prepolymers. Prepolymers can then be used, for example, to form block copolymers by means of the terminal functional group, or comb copolymers can be synthesized by free-radical copolymerization of the refunctionalized macromolecules with further free-radical polymerizable monomers for example.

So-called “living” polymerization, such as anionic polymerization, is suitable particularly for the formation of those polymers having defined molecular weight and end-group functionalization. U.S. Pat. No. 3,842,059 teaches the production of macromolecules of vinyl aromatic compounds having narrow molar mass distribution and a functional or polymerizable end group on the end of only one chain. Anionic polymerization, however, is less used in industry. The reasons responsible for this are the costs and the complex reaction of the process. Anionic polymerizable monomers and the initiators required for the reaction are usually more expensive than monomers and initiators for a free-radical polymerization. Anionic polymerization requires organic solvents which are expensive and harmful to health and the environment. Anionic polymerization, due to the growing macroanions, is also sensitive to proton-donating impurities. Chain-terminating compounds must be rigorously excluded which, however, is linked with high complexity in industrial reactors.

A much more cost-effective and rapidly viable method is free-radical polymerization. Industrially it has an overriding position since it is largely insensitive to impurities and many monomers are amenable to free-radical polymerization. End-group functionalization of polymers by means of free-radical polymerization is possible by using functional polymerization regulators. Free-radical polymerizable monomers also include (meth)acrylic compounds. The polymers of these monomers are generally characterized by colorlessness and also oxidation-stable and discoloration-stable properties. Prepolymers based on (meth)acrylic compounds therefore offer many advantages in relation to the properties mentioned. Moreover, specific glass transition temperature and polarity of the prepolymers may be controlled by the choice of monomers.

Polymerization regulators (also referred to as “regulators” in the context of this document) are those compounds which are able to assume the free-radical functionality of the ends of the growing macromolecules and then to themselves begin the growth of a new macromolecule. The growth of the macromolecule whose free-radical functionality has been adopted, is thereby terminated. The regulators are thus capable of limiting the degree of polymerization of the evolving macromolecule without substantially influencing the reaction kinetics. The tendency to transfer the free-radical function onto the polymerization regulator is specified by the transfer constant (Cₜᵣ) (cf. for example: J. Brandrup, E. H. Immergut, Polymer Handbook, 4th. Ed., pages 11/97 to 11/98).

Suitable polymerization regulators for the free-radical polymerization of (meth)acrylic compounds are, among others, haloalkanes or organic thiols, which bear another functional group in addition to the regulating group. The desired end group can thus be introduced to the polymer by choosing the appropriate regulator. Due to their high transfer tendency in free-radical polymerization, preference is given to using functional organic thiols.

Functional thiols are used especially in the production of end-group-functionalized macromolecules based on (meth)acrylic esters. This method is described for example by Boutevin (Polymer Bulletin 45, 487-494 (2001)). Functional thiols can be used here, especially since these have a transfer constant of Cₜᵣ<1 in the free-radical polymerization of (meth)acrylic esters. It is thereby ensured that up to a complete conversion of the monomers to transfer reactions can occur since the thiol is not completely consumed during the polymerization.

Amounts of residual regulators remaining in the product, however, leads to considerable disadvantages. Firstly, thiol group-containing compounds lead to a strong unpleasant odor of the products, secondly the unreacted thiol hinders the subsequent reaction to the prepolymer, and this leads to undesired side reactions. In addition to the reactive functional group which is originally intended for this reaction, namely the SH group of the thiol, due to its own nucleophilic properties, can also react with the unsaturated electrophiles for which the reaction is intended, such that it leads to the formation of low molecular weight crosslinker molecules. The reaction is shown schematically in FIG. 1. The prepolymers are used, for example, for production of high molecular weight polymers formed in a comb-like manner. For this purpose, the prepolymers equipped with copolymerizable double bonds are copolymerized with other acrylate monomers. If the low molecular weight crosslinker molecules described above are not removed from the prepolymers, this leads to uncontrolled and unwanted gelation during the polymerization in the production of comb polymers.

Purification of the prepolymers is therefore absolutely essential in the processes known from the prior art. This is an additional process step in the industrial production of macromonomers which is cost and time intensive. Due to additional process steps, the cost and time advantages generally arising from using free-radical polymerization are again reduced. The attractiveness of these processes therefore further diminishes for large-scale use in the production of such products.

In particular, the degree of functionalization and also the number-average molar mass and the molar mass distribution are important characteristics in terms of a qualitative evaluation of the macromolecules, particularly with regard to their suitability as prepolymers.

The degree of functionalization reflects the “purity” of the prepolymers. If the macromolecule bears exactly one functional end group, this corresponds to an ideal degree of functionalization of 1. Accordingly, the value is 0 or 2 if one functional group is present on neither or on both chain ends respectively. Due to termination reactions, especially the combination termination of two chains, a degree of functionalization of 1 by means of free-radical polymerization is rarely feasible.

The molar mass of the prepolymers especially influences the reactivity and the physical properties. If the average molar mass (number-average) of the prepolymers is less than around 1000 g/mol, the blocks for use in block copolymers are too short such that desired physical properties such as microphase separation could be manifested. If the number-average molecular weight is higher than approximately 20 000 g/mol, the reactivity of the end group decreases with increasing molar mass, since the functional chain end is sterically protected by an enhanced coiling of the prepolymers.

Polymers obtained by a free-radical polymerization process generally show polydispersities (polydispersity D=weight-average molecular weight M_{w}/number-average molecular weight Mₙ) of the molar masses which are significantly greater than those of the polymers produced in living polymerizations. With such a wide molar mass distribution from very short-chain up to long-chain macromolecules, molecules of many different chain lengths are present in the polymer. This has a major influence with respect to the properties of the resulting end-group-functional prepolymers described above. A number-average molar mass of 1000 g/mol to 20 000 g/mol with as narrow distribution of the molar masses as possible is therefore desirable.

### SUMMARY OF THE INVENTION

It is an object of the invention to provide an industrially efficient and cost-effective process for producing macromolecules having terminal functionalization. The manufacturing process should be able to advantageously dispense with purification steps. It is desirable that the degree of functionalization of the prepolymers, that is the number of functional groups per macromolecule, is as close to 1 as possible. The resulting macromolecules should very preferably have a narrow size distribution.

### BRIEF DESCRIPTION OF THE DRAWING

FIG. 1 illustrates the formation of low molecular weight crosslinking molecules.

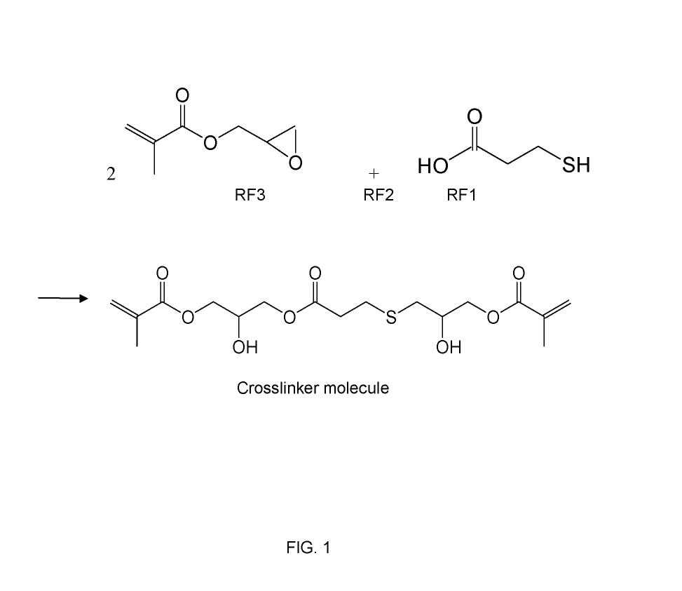

### DETAILED DESCRIPTION

The invention thus relates to a process which is suitable for producing end-group-functionalized macromolecules (“oligomer macromolecules”) whose degree of functionalization—that is the average number of functionalizations per macromolecule—is very close to 1. The process is also suitable for producing macromolecules having a very narrow polydispersity.

The object was achieved by the free-radical polymerization of alkyl(meth)acrylic compounds in the presence of functional thiols to which free-radical polymerizable vinyl aromatic compounds had been added The amount of vinyl aromatic compounds used was 5 to 20 mol % based on the amount of all monomers used.

The process according to the invention is thus such a process for producing end-group-functionalized oligomers based on acrylic monomers by means of free-radical polymerization, initiated by at least one initiator, starting from an amount of monomer of 80 to 95 mol % of at least one monomer A, selected from the group consisting of acrylates of the general formula CH₂═CH(COOR^{I}), methacrylates of the general formula CH₂═C(CH₃)(COOR^{I}), acrylamides of the general formula CH₂═CH(CONR^{II}R^{III}) and methacrylamides of the general formula CH₂═C(CH₃)(CONR^{II}R^{III}), wherein

R^{I} is an alkyl residue having one to 26 carbon atoms and R^{II} and R^{III} are each alkyl residues having one to 26 carbon atoms or hydrogen, and
5 to 20 mol % of at least one monomer B, selected from the group consisting of styrene, o-methylstyrene, m-methylstyrene, p-methylstyrene, 4-tert-butylstyrene, 2,4,6-trimethylstyrene, 4-vinylanisole, 4-trifluoromethylstyrene, 4-vinylbiphenyl, 2-vinylnaphthalene and 9-vinylanthracene,
wherein
the sum total of the amounts of monomers A and monomers B is 100 mol %,
the polymerization is controlled by means of a difunctional regulator comprising the functional groups R_{F1} and R_{F2}, where the group R_{F1} is an unsubstituted sulfanyl group and where the group R_{F2} of the regulator is selected from the list consisting of hydroxyl groups (—OH), carboxyl groups (—COOH), protected primary amino groups (—NH₂), protected secondary amines (—NHR),
   wherein
the initiator is an azo or peroxo initiator, which is selected such that it does not bear any R_{F1} and R_{F2} functional groups,
the total amount of monomer, the initiator and the regulator are initially charged,
wherein the amount of regulator is selected such that the quantitative ratio of (total used) monomers to (total used) regulator molecules is from 100:20 to 100:0.5,
the polymerization is conducted until monomer conversion reaches at least 96%,
the residual amount of regulator is less than 5 mol %,
   . . .
and in a subsequent process step the macromolecules thus obtained are reacted, in the same reactor in which the polymerization was carried out, with at least one compound Z having a functional group R_{F3} and an ethylenic double bond,
wherein at least that part of the compound Z comprising the ethylenic double bond is linked to the macromolecule by reaction of the functional group R_{F2} with the functional group R_{F3}.

In a preferred procedure, the residue R^{I} is selected to be an alkyl residue having one to 12 carbon atoms, and/or the residues R^{II} and/or R^{III} are selected to be alkyl residues having one to 12 carbon atoms or hydrogen.

The respective monomer conversion and regulator conversion can be determined at any time point by gas chromatography.

In the reaction, oligomers functionalized with a terminal ethylenic double bond are formed having substantially the same molar mass as the macromolecules formed in the first step; wherein the polymer has the same polydispersity as before the reaction with the compounds Z.

The process according to the invention is characterized in particular in that it is based on a two-stage process in which firstly an end-group-functionalized macromolecule is formed by using functional thio-regulators, which in an advantageous second step is provided specifically with the desired end group, in particular capable of polymerization. The degree of functionalization after the first step is in particular between 0.9 and 1.1. The number-average molar mass Mₙ of the end-group-functionalized oligomers after the second step is in particular from 1000 g/mol to 10 000 g/mol, the polydispersity at most 3, particularly at most 2.5, preferably at most 2 and particularly preferably at most 1.5.

Since the reaction in the second step takes place generally with short-chain electrophiles, whose molar mass is distinctly lower than that of the macromolecule, the average molar mass Mₙ is not generally altered substantially by the second step. It is advantageous if the molar mass Mₙ of the macromolecules after the first step is already in the range from 1000 g/mol to 10 000 g/mol, and/or if the polydispersity therein is already less than 3.

In the macromolecule amount produced according to the invention, in the context of this document, oligomers are under discussion. In the present case, the term “oligomer” serves only as a linguistic boundary for those polymers with high average molecular weight; and in particular the term “oligomer” is to include polymers of up to a number-average molecular weight of up to 20 000 g/mol.

The monomer mixture—and the reactant mixture—refers to the monomer batch for the polymerization, i.e. the entirety of the monomers used.

The reaction batch or starting mixture refers to the mixture of starting materials (reactants) and possibly further components present before the start of the polymerization, such as, if appropriate, the presence of initiators, regulators, accelerators or the like, and including possible solvent present.

The polymerization mixture refers to the mixture of starting materials (reactants), intermediates and end materials (products) of the polymerization located in the reactor at the respective time point t, and optionally further components present and optionally solvent present in the reactor.

The polymerization result is understood to mean the polymerization mixture after completion or after termination of the polymerization.

Details of precise amounts by number are understood to mean quantitative amounts of substance.

The polymerization of acrylic monomers takes place in the presence of vinyl aromatic compounds and at least one thiol group-containing regulator (referred to as thio-regulator below).

The process according to the invention can be used in principle for polymerizing the customary polymerizable acrylic monomers.

Examples of particularly suitable acrylic monomers according to the invention, that is, monomers A, are methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-di methyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofufuryl acrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate and branched isomers thereof such as isobutyl acrylate, isooctyl acrylate, isooctyl methacrylate, 2-ethylhexyl acrylate or 2-ethylhexyl methacrylate.

Suitable vinyl aromatic compounds, i.e. the monomers in the context of group B, are above all styrene and its derivatives alkylated on the ring such as o-methylstyrene, m-methylstyrene, p-methylstyrene, 4-tert-butylstyrene, 2,4,6-trimethylstyrene. Also vinyl aromatic compounds such as 4-vinylanisole, 4-trifluoromethylstyrene, 4-vinylbiphenyl, 2-vinylnaphthalene, 9-vinylanthracene.

The regulators used are at least difunctional regulators having at least the functional groups R_{F1} and R_{F2}. In this case, the group R_{F1} is an unsubstituted sulfanyl group—also referred to as a thiol group in the context of this document —, and the group R_{F2} of the regulator is such a group that withstands the polymerization reaction unaffected (or may be converted into such a form that it withstands the polymerization reaction unaffected) and can be reacted with other functional groups in a further step. The group R_{F2} is very preferably selected from the group consisting of hydroxyl groups (—OH), carboxyl groups (—COOH), protected primary amino groups (—NH₂) and protected secondary amines (—NHR). In this case, the unsubstituted sulfanyl group is employed for regulating the polymerization reaction, whereas the group R_{F2} remains inert in the actual polymerization. If the group R_{F2} is one that itself acts as a regulator or could lead to side reactions, it is protected with a protecting group prior to use of the regulator. In particular, if primary or secondary amines are selected as functional groups R_{F2}, these are very preferably used in protected form, i.e. the appropriate groups of the regulator are provided with a protecting group prior to their use.

A single regulator or a combination of two or more regulators of the type mentioned may be used, where in the case of more than one regulator, the total amount of regulator to be used mentioned above refers to the entirety of all regulators used of the type determined according to the invention.

The regulators selected can be for example—without being exhaustive—particularly the following substances:

2-mercaptoethanol, 3-mercaptopropanol, 4-mercaptobutanol, 5-mercaptobutanol, 6-mercaptohexanol, 11-mercaptoundecanol, 16-mercaptohexadecanol, 1-mercapto-2-propanol, 3-mercapto-1-propanol, 3-mercapto-1-hexanol, 2-methyl-3-sulfanylpropionic acid, 4-mercaptobutyric acid, 6-mercaptohexanoic acid, 2-mercaptopropionic acid, 3-mercaptopropionic acid, mercaptoacetic acid, 11-mercaptoundecanoic acid, 16-mercaptohexadecanoic acid, 2-aminoethanethiol hydrochloride.

Particularly excellent regulators from the above list are 2-aminoethanethiol hydrochloride, 2-mercaptoethanol, 3-mercaptopropionic acid, 2-mercaptopropionic acid and 2-mercaptoacetic acid.

The amount of regulator used, i.e. of the functional thiol, is from 0.5 to 20 mol % based on the cumulative total amount of vinyl aromatic compounds and alkyl(meth)acrylic compounds, i.e. the quantitative ratio of (total used) monomers to (total used) regulator molecules is from 0.5:100 to 20:100. The amount of regulator used is preferably from 1 to 10 mol % based on the cumulative total amount of starting monomers.

The initiators used may be all initiators known for free-radical polymerizations such as peroxides, azo compounds and peroxosulfates, insofar as they do not bear either of the functional groups R_{F1} and R_{F2}. Initiator mixtures may also be used. Particularly preferred initiators are 2,2′-azobis(2-methylpropionitrile) (AIBN), 2,2′-azobis(2-methylbutyronitrile) and bis(4-tert-butylcyclohexyl) peroxydicarbonate.

In this case, the regulator is added preferably in an excess amount relative to the initiator. The amount of excess of regulator in this case relative to the initiator is preferably at least double, particularly at least 5-fold and particularly preferably at least 10-fold.

The polymerization is carried out by initially charging and mixing the total amount of monomer, regulator and initiator and optionally the solvent. All conventional solvents for polymerizations based on acrylate can be used as solvent. It is possible to use all inert and aprotic solvents.

The temperature control depends on the initiator selected and the solvent selected.

The polymerization reaction can be monitored online. The polymerization reaction can be controlled online by using near-infrared spectroscopy and are known, compare, for example “On-line Determination of the Conversion in a Styrene Bulk Polymerization Batch Reactor using Near-Infrared Spectroscopy”; Journal of Applied Polymer Science, Volume 84 (2002), Issue 1, pages 90-98; the method mentioned therein is advantageously applied to the process according to the invention. An overview of other methods for online determination of the polymerization reaction is to be found in “Recent Developments in Hardware Sensors for the On-Line Monitoring of Polymerization Reactions”, J.M.S.-Rev. Macromol. Chem Phys., C39(1), 57-134 (1999).

Alternatively, the polymerization reaction can be determined by sampling and analysis of the samples taken by known methods.

The polymerization is conducted until monomer conversion reaches at least 96%, preferably at least 97%. Furthermore, the residual amount of regulator should be less than 5 mol %, preferably less than 3 mol % and particularly preferably less than 1 mol %.

With such low residual amounts of regulator purification of the macromolecules obtained can be dispensed with, since the residual amount of regulator is so low that firstly no unpleasant odor is still noticeable and secondly, in particular, no adverse effects on the subsequent refunctionalization reaction by gelation due to crosslinking reactions of the thiol with the electrophilic compound Z are to be expected.

To equip the macromolecules obtained in the first step with olefinic double bonds, whereby they can be further polymerized, these macromolecules are reacted with at least one compound Z in a subsequent process step, wherein the compound Z has at least one functional group R_{F3} and at least one olefinic double bond. The reaction can be effected in particular by a coupling reaction such as an addition or substitution reaction, a substitution reaction being particularly preferred. If the groups R_{F2} (that is the groups located on the oligomer) are present in protected form, the protecting group is preferably firstly removed such that the coupling reaction may be carried out.

The coupling reaction may be carried out in particular by reaction of the—if appropriate, deprotected—functional group R_{F2} with the functional group R_{F3} of the compound Z, wherein the functional group R_{F3} is selected such that it is exceptionally suitable for addition or substitution reactions with the functional group R_{F2}. The compound Z is selected such that it has at least one olefinically unsaturated double bond in addition to the functional group R_{F3}, wherein at least that part of the compound Z comprising the olefinic double bond is linked by the coupling reaction to the macromolecule obtained in the first step.

In a preferred procedure, the reaction of the functional group R_{F2} of the macromolecule with the functional group R_{F3} of the compound Z is carried out with catalysis. Suitable catalysts for this reaction are, for example, reagents such as dimethylbenzylamine or tetraethylammonium bromide.

The compound Z is particularly preferably selected from the list consisting of acrylic anhydride, methacrylic anhydride, glycidyl acrylate, glycidyl methacrylate, maleic anhydride, acryloyl chloride, methacryloyl chloride, 2-isocyanatoethyl acrylate, 2-isocyanatoethyl methacrylate, 4-chloromethylstyrene, itaconic anhydride, 3,4-epoxycyclohexylmethyl acrylate and 3,4-epoxycyclohexylmethyl methacrylate.

If the compound Z has a hydrocarbon chain as skeleton and the olefinically unsaturated double bond is located on an end carbon atom of this hydrocarbon chain, this double bond is present even after the introduction into the oligomer on an end carbon atom of the (thus modified) end-group-functionalized oligomer.

In a preferred procedure, the reaction of the group R_{F2} with the functional group R_{F3} is carried out at a temperature of at least 100° C. Particular preference is given to proceeding such that the reaction of the group R_{F2} with the functional group R_{F3} is carried out in the same reactor in which the polymerization has already been carried out.

The process according to the invention is preferably carried out such that the end-group-functionalized oligomers obtained have on average 0.9 to 1.1 ethylenic double bonds introduced by the compound Z.

Macromolecules that have been functionalized with a double bond are of interest as comonomers—also referred to as “macromonomers”. These may serve in turn as monomers in polymerization reactions. In this manner, for example, block copolymers can be produced. In a simple manner, comb polymers are thus also obtainable.

By means of conventional polymerization, such macromolecules equipped in particular with terminal olefinic double bonds, i.e. with a double bond between the last and penultimate carbon atom of the respective molecule chain, cannot be satisfactorily obtained since the double bonds react in the scope of the polymerization and therefore no terminal double bonds could be incorporated specifically in the resulting macromolecule. It is difficult, furthermore, to produce such macromolecules so that their functionality tends towards 1—that is on average one double bond is present per macromolecule—and that they have a narrow size distribution, i.e. a low polydispersity. Narrow size distribution macromolecules are then particularly useful if all side chains of the comb polymer should have substantially the same chain length.

Macromolecules which meet the abovementioned requirements can be obtained by the process according to the invention. The invention therefore also relates to end-group-functionalized oligomers which each bear a terminal olefinic double bond.

The oligomers according to the invention are in particular those, based on acrylate, which have a number-average molecular weight in the range of 1000 g/mol to 20 000 g/mol, particularly to 10 000 g/mol, and/or whose polydispersity is not greater than 2.5, preferably not greater than 2.0, very preferably not greater than 1.5, and/or which have a degree of functionalization from 0.9 to 1.1, wherein particularly advantageously at least 98%, preferably at least 99.5% of the chains bear at least one olefinic double bond.

### EXAMPLES

The invention will be illustrated in detail below by means of examples. In addition to the test methods already described above, the following methods are used:

### Methods

The values reported in this document for the number-average molar mass Mₙ, the weight-average molar mass M_{w} and the polydispersity relate to the determination by gel permeation chromatography (GPC) and the evaluation of such measurements.

The determination is carried out using a clear filtered 100 μl sample (sample concentration 4 g/l). The eluent employed is THF comprising 0.1 vol % trifluoroacetic acid. The measurement is conducted at 25° C. The pre-column used is a column type PSS-SDV, 5 μm, 10³ Å, 8.0 mm*50 mm (values here and below in the sequence: type, particle size, porosity, internal diameter*length; 1 Å=10⁻¹⁰ m). For the separation, a combination is used of the columns of the type PSS-SDV, 5 μm, 10³ Å and also 10⁵ Å and 10⁶ Å, in each case 8.0 mm*300 mm (columns from Polymer Standards Service; detection by means of differential refractometer Shodex RI71). The flow rate is 1.0 ml per minute. The calibration is against PMMA standards (polymethyl methacrylate calibration).

300 MHz ¹H-NMR spectroscopic measurements were recorded using a Bruker Advance DRX 300 NMR spectrometer at room temperature.

### Example

The amounts used for the following reaction can be found in Table 1.

### First Process Step

A conventional 2.5 L glass reactor for free-radical polymerization was filled with methyl methacrylate (MMA) [for macromonomers MM1 to MM15] or n-butyl acrylate (n-BA) [for macromonomers MM16 to MM21], optionally styrene, mercaptoethanol (ME) and ethyl acetate (50% by weight) (cf. the respective values in Table 1). After passing nitrogen gas through for 45 minutes with stirring, the reactor internal temperature was raised to 70° C. and Vazo® 67 (2,2′-azobis(2-methylbutyronitrile) from DuPont) was added. Subsequently, the external heating bath was heated to 75° C. and the reaction was conducted constantly at this external temperature. The conversions of the monomers and of the thiol after 15 h reaction time are found in Table 1.

Second Process Step (Refunctionalization with the Compound Z)

An amount of isocyanatoethyl methacrylate equimolar to the amount of mercaptoethanol used was added to the solution after 15 h reaction time. The reaction was carried out for a further 12 h at a heating bath temperature of 75° C., in order to obtain the end-group-functionalized oligomer with olefinic double bond, the macromonomer.

### Production of Comb Polymer

Subsequently, 600 g of 2-ethylhexyl acrylate and 800 g of ethyl acetate are added to the dissolved macromonomer. The polymerizability of the macromonomers used can be found in Table 2.

After passing nitrogen gas through for 45 minutes with stirring, the reactor was heated to 58° C. and 0.35 g of Vazo® 67 were added. Subsequently, the external heating bath was heated to 70° C. and the reaction was conducted constantly at this external temperature. After 1 h reaction time, a further 0.35 g of Vazo® 67 were added. Over a time period of 5 h, depending on the increase in viscosity, the mixture was diluted every hour with 100 g to 200 g of ethyl acetate in each case. For the reduction of the residual monomers, 1 g of bis(4-tert-butylcyclohexyl) peroxydicarbonate was added in each case after 6 and 7 h and in between the mixture was further diluted with 100 g of ethyl acetate. The reaction was terminated after 24 h reaction time and cooled to room temperature.

TABLE 1

| | | | | Vazo ® | Mₙ | | | Monomer | Thiol | Isocanatoethyl |
|---|---|---|---|---|---|---|---|---|---|---|
| | | Styrene | ME | 67 | [g/mol] | PD | F | conversion | conversion | methacrylate |
| | MMA | | | | | | | | | |
| MM1 | 90.11 g | — | 7.81 g | 0.57 g | 1950 | 1.5 | 1.0 | 97% | 83% | 15.52 g |
| | 90 mol % | — | 10 mol % | 0.3 mol % | | | | | | |
| | 100:0 | | | added | | | | | | |
| MM2 | 98.12 g | — | 1.56 g | 0.57 g | 4900 | 1.7 | 0.98 | 97% | 83% | 3.10 g |
| | 98 mol % | — | 2 mol % | 0.3 mol % | | | | | | |
| | | | | added | | | | | | |
| | 100:0 | | | | | | | | | |
| MM3 | 99.12 g | — | 0.78 g | 0.57 g | 9600 | 2 | 0.96 | 98% | 84% | 1.55 g |
| | 99 mol % | — | 1 mol % | 0.3 mol % | | | | | | |
| | | | | added | | | | | | |
| | 100:0 | | | | | | | | | |
| MM4 | 87.4 g | 2.81 g | 7.81 g | 0.57 g | 2050 | 1.6 | 1.0 | 97% | 90% | 15.52 g |
| | 87.30 mol % | 2.70 mol % | 10 mol % | 0.3 mol % | | | | | | |
| | | | | added | | | | | | |
| | 97:3 | | | | | | | | | |
| MM5 | 95.17 g | 3.06 g | 1.56 g | 0.57 g | 5200 | 1.85 | 0.98 | 97% | 90% | 3.10 g |
| | 95.06 mol % | 2.94 mol % | 2 mol % | 0.3 mol % | | | | | | |
| | | | | added | | | | | | |
| | 97:3 | | | | | | | | | |
| MM6 | 96.15 g | 3.09 g | 0.78 g | 0.57 g | 9850 | 2 | 0.95 | 97% | 90% | 1.55 g |
| | 96.03 mol % | 2.97 mol % | 1 mol % | 0.3 mol % | | | | | | |
| | | | | added | | | | | | |
| | 97:3 | | | | | | | | | |
| MM7 | 85.60 g | 4.69 g | 7.81 g | 0.57 g | 2100 | 1.7 | 0.99 | 97% | 96% | 15.52 g |
| | 85.50 mol % | 4.50 mol % | 10 mol % | 0.3 mol % | | | | | | |
| | | | | added | | | | | | |
| | 95:5 | | | | | | | | | |
| MM8 | 93.21 g | 5.10 g | 1.56 g | 0.57 g | 5450 | 1.9 | 0.98 | 97% | 96% | 3.10 g |
| | 93.10 mol % | 4.90 mol % | 2 mol % | 0.3 mol % | | | | | | |
| | | | | added | | | | | | |
| | 95:5 | | | | | | | | | |
| MM9 | 94.16 g | 5.16 g | 0.78 g | 0.57 g | 9750 | 2.3 | 0.96 | 97% | 96% | 1.55 g |
| | 94.05 mol % | 4.95 mol % | 1 mol % | 0.3 mol % | | | | | | |
| | | | | added | | | | | | |
| | 95:5 | | | | | | | | | |
| MM10 | 81.1 g | 9.37 g | 7.81 g | 0.57 g | 2200 | 2.1 | 0.99 | 97% | 97% | 15.52 g |
| | 81.00 mol % | 9.00 mol % | 10 mol % | 0.3 mol % | | | | | | |
| | | | | added | | | | | | |
| | 90:10 | | | | | | | | | |
| MM11 | 88.31 g | 10.21 g | 1.56 g | 0.57 g | 5500 | 2.3 | 0.96 | 97% | 97% | 3.10 g |
| | 88.20 mol % | 9.80 mol % | 2 mol % | 0.3 mol % | | | | | | |
| | | | | added | | | | | | |
| | 90:10 | | | | | | | | | |
| MM12 | 89.21 g | 10.31 g | 0.78 g | 0.57 g | 9850 | 2.6 | 0.95 | 97% | 97% | 1.55 g |
| | 89.10 mol % | 9.90 mol % | 1 mol % | 0.3 mol % | | | | | | |
| | | | | added | | | | | | |
| | 90:10 | | | | | | | | | |
| MM13 | 72.09 g | 18.75 g | 7.81 g | 0.57 g | 2500 | 2.1 | 0.98 | 97% | 99% | 15.52 g |
| | 72.00 mol % | 18.00 mol % | 10 mol % | 0.3 mol % | | | | | | |
| | | | | added | | | | | | |
| | 80:20 | | | | | | | | | |
| MM14 | 78.49 g | 20.41 g | 1.56 g | 0.57 g | 5850 | 2.4 | 0.95 | 97% | 99% | 3.10 g |
| | 78.40 mol % | 19.60 mol % | 2 mol % | 0.3 mol % | | | | | | |
| | | | | added | | | | | | |
| | 80:20 | | | | | | | | | |
| MM15 | 79.30 g | 20.62 g | 0.78 g | 0.57 g | 9950 | 2.95 | 0.91 | 97% | 99% | 1.55 g |
| | 79.20 mol % | 19.80 mol % | 1 mol % | 0.3 mol % | | | | | | |
| | | | | added | | | | | | |
| | 80:20 | | | | | | | | | |
| | n-BA | | | | | | | | | |
| MM16 | 115.35 g | — | 7.81 g | 0.57 g | 1950 | 1.5 | 1.0 | 97% | 83% | 15.52 g |
| | 90 mol % | — | 10 mol % | 0.3 mol % | | | | | | |
| | 100:0 | | | added | | | | | | |
| MM17 | 125.61 g | — | 1.56 g | 0.57 g | 4900 | 1.7 | 0.98 | 97% | 83% | 3.10 g |
| | 98 mol % | — | 2 mol % | 0.3 mol % | | | | | | |
| | | | | added | | | | | | |
| | 100:0 | | | | | | | | | |
| MM18 | 126.89 g | — | 0.78 g | 0.57 g | 9600 | 2 | 0.96 | 98% | 84% | 1.55 g |
| | 99 mol % | — | 1 mol % | 0.3 mol % | | | | | | |
| | | | | added | | | | | | |
| | 100:0 | | | | | | | | | |
| MM19 | 109.59 g | 4.69 g | 7.81 g | 0.57 g | 2050 | 1.6 | 1.0 | 97% | 90% | 15.52 g |
| | 85.50 mol % | 4.50 mol % | 10 mol % | 0.3 mol % | | | | | | |
| | | | | added | | | | | | |
| | 95:5 | | | | | | | | | |
| MM20 | 119.33 g | 5.10 g | 1.56 g | 0.57 g | 5200 | 1.85 | 0.98 | 97% | 90% | 3.10 g |
| | 93.10 mol % | 4.90 mol % | 2 mol % | 0.3 mol % | | | | | | |
| | | | | added | | | | | | |
| | 95:5 | | | | | | | | | |
| MM21 | 120.54 g | 5.16 g | 0.78 g | 0.57 g | 9850 | 2 | 0.95 | 97% | 90% | 1.55 g |
| | 94.05 mol % | 4.95 mol % | 1 mol % | 0.3 mol % | | | | | | |
| | | | | added | | | | | | |

95:5

TABLE 2

| | Macromonomer | Comment |
|---|---|---|
| PSA 1 | MM 1 | gelled |
| PSA 2 | MM 2 | gelled |
| PSA 3 | MM 3 | gelled |
| PSA 4 | MM 4 | gelled |
| PSA 5 | MM 5 | gelled |
| PSA 6 | MM 6 | gelled |
| PSA 7 | MM 7 | gel not formed |
| PSA 8 | MM 8 | gel not formed |
| PSA 9 | MM 9 | gel not formed |
| PSA 10 | MM 10 | gel not formed |
| PSA 11 | MM 11 | gel not formed |
| PSA 12 | MM 12 | gel not formed |
| PSA 13 | MM 13 | gel not formed |
| PSA 14 | MM 14 | gel not formed |
| PSA 15 | MM 15 | gel not formed |
| PSA 16 | MM 16 | gelled |
| PSA 17 | MM 17 | gelled |
| PSA 18 | MM 18 | gelled |
| PSA 19 | MM 19 | gel not formed |
| PSA 20 | MM 20 | gel not formed |
| PSA 21 | MM 21 | gel not formed |

The results demonstrate that, at the same monomer conversion, consumption of the regulator of more than 95% (based on the amount of regulator initially used) only takes place with the process according to the invention. Therefore, only in the inventive examples does no gelation occur in the second process step. Despite the extensive consumption of regulator, very high monomer conversions can be achieved, and the polydispersity and the degree of functionality are in each case in the required range of values.

1: A process for producing end-group-functionalized oligomers based on acrylic monomers by means of free-radical polymerization, initiated by at least one initiator, starting from an amount of monomer of
80 to 95 mol % of at least one monomer A, selected from the group consisting of acrylates of the general formula CH₂═CH(COOR^{I}), methacrylates of the general formula CH₂═C(CH₃)(COOR^{I}), acrylamides of the general formula CH₂═CH(CONR^{II}R^{III}) and methacrylamides of the general formula CH₂═C(CH₃)(CONR^{II}R^{III}), wherein
R^{I} is an alkyl residue having one to 26 carbon atoms and R^{II} and R^{III} are each alkyl residues having one to 26 carbon atoms or hydrogen,
and
5 to 20 mol % of at least one monomer B, selected from the group consisting of styrene, o-methylstyrene, m-methylstyrene, p-methylstyrene, 4-tert-butylstyrene, 2,4,6-trimethylstyrene, 4-vinylanisole, 4-trifluoromethylstyrene, 4-vinylbiphenyl, 2-vinylnaphthalene and 9-vinylanthracene,
wherein
the sum total of the amounts of monomers A and monomers B is 100 mol %,
the polymerization is controlled by means of a difunctional regulator comprising the functional groups R_{F1} and R_{F2}, where the group R_{F1} is an unsubstituted sulfanyl group and where the group R_{F2} of the regulator is selected from the group consisting of hydroxyl groups (—OH), carboxyl groups (—COOH), protected primary amino groups (—NH₂), and protected secondary amines (—NHR),
wherein
the initiator is an azo or peroxo initiator, which is selected such that it does not bear any R_{F1} and R_{F2} functional groups,
the total amount of monomer, the initiator and the regulator are initially charged,
wherein the amount of regulator is selected such that the quantitative ratio of (total used) monomers to (total used) regulator molecules is from 100:20 to 100:0.5,
the polymerization is conducted until monomer conversion reaches at least 96%,
the residual amount of regulator is less than 5 mol %,
and in a subsequent process step the macromolecules thus obtained are reacted, in the same reactor in which the polymerization was carried out, with at least one compound Z having a functional group R_{F3} and an ethylenic double bond,
wherein at least that part of the compound Z comprising the ethylenic double bond is linked to the macromolecule by reaction of the functional group R_{F2} with the functional group R_{F3}.

2: The process as claimed in claim 1, wherein R^{I} is an alkyl residue having one to 12 carbon atoms.

3: The process as claimed in claim 1, wherein R^{II} and/or R^{III} are each alkyl residues having one to 12 carbon atoms or hydrogen.

4: The process as claimed in claim 1, wherein the reaction of the group R_{F2} with the functional group R_{F3} is a substitution reaction.

5: The process as claimed in claim 1, wherein the regulator is used in an at least 10-fold excess amount relative to the initiator.

6: The process as claimed in claim 1, wherein the quantitative ratio of (total used) monomers to (total used) regulator molecules is from 100:10 to 100:1.

7: The process as claimed in claim 1, wherein the regulators used are 2-aminoethanethiol hydrochloride, 2-mercaptoethanol, 3-mercaptopropionic acid, 2-mercaptopropionic acid and/or 2-mercaptoacetic acid.

8: The process as claimed in claim 1, wherein the compound Z having the functional group R_{F3} and an ethylenic double bond is selected from the group consisting of acrylic anhydride, methacrylic anhydride, glycidyl acrylate, glycidyl methacrylate, maleic anhydride, acryloyl chloride, methacryloyl chloride, 2-isocyanatoethyl acrylate, 2-isocyanatoethyl methacrylate, 4-chloromethylstyrene, itaconic anhydride, 3,4-epoxycyclohexylmethyl acrylate, and epoxycyclohexyl methyl methacrylate.

9: The process as claimed in claim 1, wherein the number-average molecular weight of the resulting macromolecules is in the range of 1000 g/mol to 20 000 g/mol.

10: The process as claimed in claim 1, wherein the polydispersity of the resulting polymers is not greater than 2.5.

11: The process as claimed in claim 1, wherein the resulting macromolecules have on average 0.9 to 1.1 ethylenic double bonds introduced by the compound Z.

12: The process as claimed in claim 1, wherein the polymerization product is purified by removing unreacted styrene derivatives from the polymerization product.

13: An oligomer obtained by the process of claim 1.
